(19) United States
(12) Patent Application Publication
(10) Pub. No.: US 2015/0220120 A1
(43) Pub. Date: Aug. 6, 2015

(54) DISPLAY DEVICE HAVING A TOUCH PANEL

(71) Applicant: SAMSUNG DISPLAY CO., LTD., Yongin-city (KR)

(72) Inventor: DONGSUN LEE, Chungcheongnam-do (KR)

(21) Appl. No.: 14/457,259

(22) Filed: Aug. 12, 2014

(30) Foreign Application Priority Data
Feb. 6, 2014 (KR) 10-2014-0013709

(51) Int. Cl. G06F 1/16; G06F 3/041

(52) U.S. Cl. CPC G06F 1/1652; G06F 3/0412

(57) ABSTRACT

Provided is a display device. The display device includes a rear protection film including a shape memory alloy. A touch panel is disposed on the rear protection film. The touch panel is configured to detect a user's touch. A bendable display panel is disposed on the touch panel.

### CROSS-REFERENCE TO RELATED APPLICATION

This U.S. non-provisional patent application claims priority under 35 U.S.C. §119 to Korean Patent Application No. 10-2014-0013709, filed on Feb. 6, 2014, the disclosure of which is incorporated by reference herein in its entirety.

### TECHNICAL FIELD

Exemplary embodiments of the present inventive concept relate to a display device, and more particularly to a display device having a touch panel.

### DISCUSSION OF RELATED ART

Touch panels may include an interface between a display and a user. Touch panels may include input devices that interface with a device by contacting a screen through user's hands or a pen.

A touch panel may include an input device which may control a computer through a user's finger contacting a screen. Touch panels may be included in various devices, such as mobile phones, personal digital assistants (PDAs), liquid crystal displays (LCDs) or cathode-ray tuber (CRTs).

Touch panels may be disposed on a display panel and may detect a user's touch.

### SUMMARY

Exemplary embodiments of the present inventive concept provide a display device that may increase power consumption efficiency and bending characteristics.

Exemplary embodiments of the present inventive concept provide a display device which may have increased durability against an external impact.

Exemplary embodiments of the present inventive concept provide a display device. The display device includes a rear protection film including a shape memory alloy. A touch panel is disposed on the rear protection film. The touch panel is configured to detect a user's touch. A bendable display panel is disposed on the touch panel.

The shape memory alloy may include nitinol.

The rear protection film may have a thickness of about 50 μm to about 100 μm.

A portion of the rear protection film may be bendable.

The bendable display panel may include an organic light emitting display panel, an electrophoretic display panel, or an electrowetting display panel.

The display device may include an electronic book or an electronic paper.

The display device may include an upper adhesion film between the display panel and the touch panel.

The bendable display panel may include a plurality of pixel areas and a non-display area surrounding the plurality of pixel areas.

The touch panel may include a lower substrate and a first conductive layer disposed on the lower substrate. A second conductive layer may face the first conductive layer. A dot spacer may be disposed on the first conductive layer. The dot spacer may electrically connect the first and second conductive layers to each other.

The first conductive layer may include a first touch line extending in a first direction and overlapping the non-display area. The second conductive layer may include a second touch line extending in a second direction different from the first direction and overlapping the non-display area.

The first touch line may include first touch electrodes which are connected to each other in the first direction. The first touch electrodes may have a mesh shape. Edges of the first touch electrodes may have a diamond shape. The second touch line may include second touch electrodes which may be connected to each other in the second direction. The second touch electrodes may have a mesh shape. Edges of the second touch electrodes may have a diamond shape.

The dot spacer may have a height less than a cell gap between the lower substrate and the upper substrate.

The first and second conductive layers may include silver (Ag) car copper (Cu).

The first and second conductive layers may be substantially opaque.

The touch panel may include an upper substrate disposed on the second conductive layer.

A portion of the touch panel may be bendable.

A lower adhesion film may be disposed between the touch panel and the rear protection film.

### BRIEF DESCRIPTION OF THE DRAWINGS

The above and other features of the present inventive concept will become more apparent by describing in detail exemplary embodiments thereof, with reference to the accompanying drawings in which:

FIG. 1 is a schematic perspective view of a display device according to an exemplary embodiment of the present inventive concept;

FIG. 2 is a schematic cross-sectional view illustrating a touch panel that is provided in the display device according to an exemplary embodiment of the present inventive concept;

FIG. 3 is a schematic perspective view illustrating a lower substrate and a first conductive layer of the touch panel that is included in the display device according to an exemplary embodiment of the present inventive concept;

FIG. 4 is a schematic perspective view illustrating an upper substrate and a second conductive layer of the touch panel that is included in the display device according to an exemplary embodiment of the present inventive concept; and

FIG. 5 is a schematic cross-sectional view illustrating the first conductive layer and the second conductive layer of the touch panel that is included in the display device according to an exemplary embodiment of the present inventive concept.

### DETAILED DESCRIPTION OF THE EMBODIMENTS

Exemplary embodiments of the present inventive concept will be described below in more detail with reference to the accompanying drawings. Exemplary embodiments of the present inventive concept may, however, be embodied in different forms and should not be construed as limited to the exemplary embodiments set forth herein.

Like reference numerals may refer to the same or similar elements in the specification and drawings. In the drawings, the sizes, or thicknesses of layers and regions may be exaggerated for clarity. It will be understood that when an element such as a layer, film, region, or substrate is referred to as being “on” another element, it can be directly on the other element or intervening elements may also be present.

Hereinafter, a display device according to exemplary embodiments of the present inventive concept will be described in more detail with reference to the accompanying drawings.

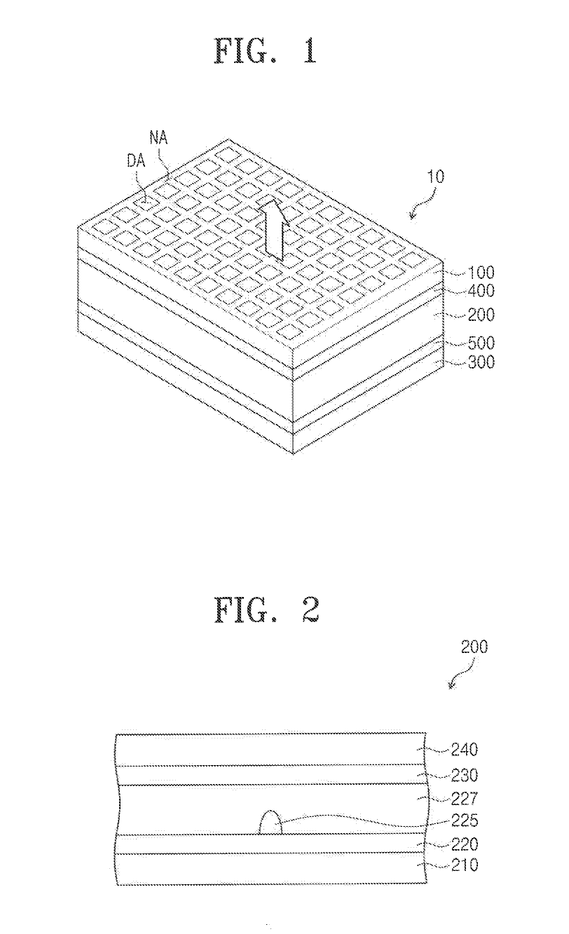

FIG. 1 is a schematic perspective view of a display device according to an exemplary embodiment of the present inventive concept.

Referring to FIG. 1, a display device 10 according to an exemplary embodiment of the present inventive concept may include a rear protection film 300 configured to protect a display panel 100, a touch panel 200 disposed on the rear protection film 300 and configured to detect a touch, and the display panel 100 disposed on the touch panel 200. The display panel 100 may be a bendable display panel.

Exemplary embodiments of the present inventive concept are not limited to the display device 10. For example, the display device 10 may be an electronic book or an electronic paper.

The display panel 100 may be an organic light emitting display (OLED) panel, an electrophoretic display panel, and/or an electrowetting display panel. In the exemplary embodiments of the present inventive concept, the OLED panel may be described as an example.

The display panel 100 may include a base substrate (not shown), a thin film transistor (TFT) (not shown), a first electrode (not shown), an organic emission layer (not shown), and a second electrode (not shown).

The display panel 100 may include a plurality of pixel areas DA and a non-display area NA surrounding the plurality of pixel areas DA. An image may be displayed on the pixel areas DA and might not be displayed on the non-display area NA. A pixel may be disposed in the pixel area DA. In other words, the image may be displayed on a top surface of the display panel 100 (for example, in an arrow direction of FIG. 1).

The TFT may be disposed on the base substrate. The TFT may apply an electric field to the first electrode and the second electrode which may correspond to each other and may apply the electric field to the organic emission layer.

The TFT may include a semiconductor layer (not shown), a gate electrode (not shown) overlapping the semiconductor layer, a source electrode (not shown), and a drain electrode (not shown). The first electrode may be disposed on the TFT and may be electrically connected to the TFT. The organic emission layer may be disposed on the first electrode. The second electrode may be disposed on the organic emission layer.

The first electrode may be an anode electrode, and the second electrode may be a cathode electrode. The organic emission layer may be a multilayer film including a hole injection layer (HIL), a hole transporting layer (HTL), an emission layer (EML), an electron transporting layer (ETL), and an electron injection layer (EIL).

A user may touch the top surface of the display panel 100 and the display panel 100 may be bent. In other words, the display panel 100 may be flexible.

The display device 10 may include an upper adhesion film 400, which may be disposed between the display panel 100 and the touch panel 200. The display panel 100 and the touch panel 200 may be attached to each other through the upper adhesion film 400.

The upper adhesion film 400 may be a common adhesion film however; the present inventive concept is not limited to a particular adhesion film. For example, the upper adhesion film 400 may be a pressure sensitive adhesive (PSA) film.

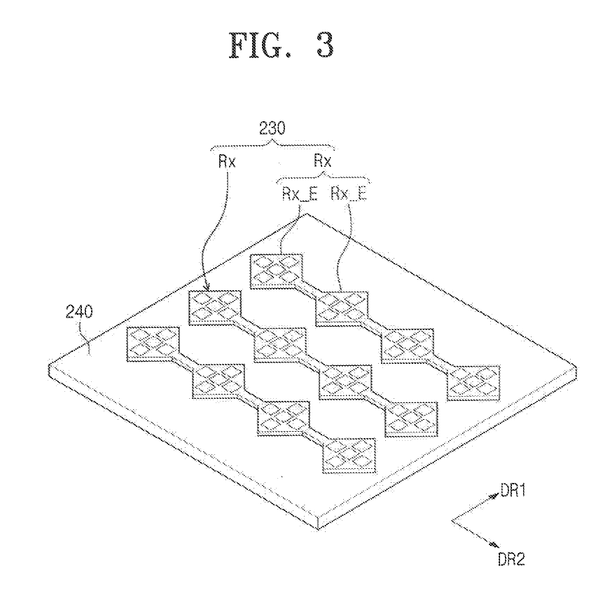

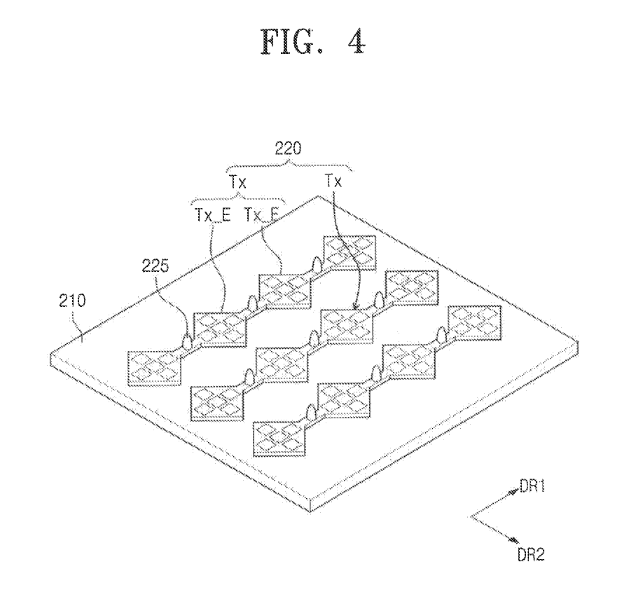

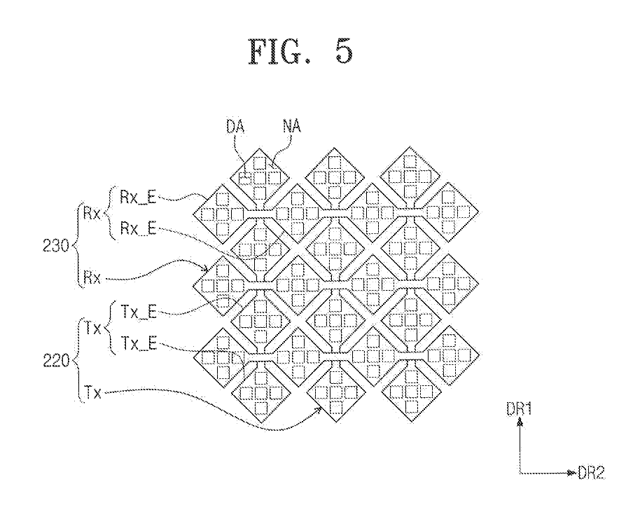

FIG. 2 is a schematic cross-sectional view illustrating a touch panel that is included in the display device according to an exemplary embodiment of the present inventive concept, FIG. 3 is a schematic perspective view illustrating a lower substrate and a first conductive layer of the touch panel that is included in the display device according to an exemplary embodiment of the present inventive concept, FIG. 4 is a schematic perspective view illustrating an upper substrate and a second conductive layer of the touch panel that is provided in the display device according to an exemplary embodiment of the present inventive concept, and FIG. 5 is a schematic cross-sectional view illustrating the first conductive layer and the second conductive layer of the touch panel that is included in the display device according to an exemplary embodiment of the present inventive concept.

Referring to FIGS. 2 to 5, the touch panel 200 may include a lower substrate 210, a first conductive layer 220 disposed on the lower substrate 210, a second conductive layer 230 facing the first conductive layer 220, and a dot spacer 225.

The lower substrate 210 may be a transparent insulation substrate including glass or plastic.

The first conductive layer 220 may be disposed on the lower substrate 210. The first conductive layer 220 may include silver (Ag) and/or copper (Cu). The first conductive layer 220 may be substantially opaque.

The first conductive layer 220 may include a first touch line Tx. The first touch line Tx may extend in a first direction (for example, a direction DR1 of FIGS. 3 to 5). The first touch line Tx may overlap the non-display area NA and need not overlap the pixel area DA. A plurality of first touch lines Tx may be included in the first conductive layer 220. The first touch lines Tx may be spaced apart from each other in a second direction (for example, a direction DR2 in FIGS. 3 to 5) that is different from the first direction. The first touch lines Tx may include a plurality of first touch electrodes Tx_E. The first touch electrodes Tx_E may have a mesh shape and edges of the first touch electrodes Tx_E may approximately form a diamond shape. The first touch electrodes Tx_E may be connected to each other in the first direction DR1. Although the first touch electrodes Tx_E are illustrated in a diamond shape in FIGS. 3 to 5, exemplary embodiments of the present inventive concept are not limited thereto. For example, the diamond shape may have a side that has a stair shape along the pixel area DA. An inside of the first touch electrodes Tx_E may have the mesh shape however, exemplary embodiments of the present inventive concept are not limited thereto and the first touch electrodes Tx_E may have various shapes.

The second conductive layer 230 may face the first conductive layer 220. A second touch line Rx may extend in the second direction. The second touch line Rx may overlap the non-display area NA and need not overlap the pixel area DA. The second conductive layer 230 may include a plurality of second touch lines Rx, and the second touch lines Rx may be spaced apart from each other in the first direction DR1. The second touch lines Rx may include a plurality of second touch electrodes Rx_E. The second touch electrodes Rx_E may have a mesh shape and edges of the second touch electrodes Rx_E may approximately form a diamond shape. The second touch electrodes Rx_E may be connected to each other in the second direction DR2. An inside of the second touch electrode Rx_E may have a mesh shape however, exemplary embodiments of the present inventive concept are not limited thereto and the second touch electrodes Rx_E may have various shapes. Although the second touch electrodes Rx_E are illustrated in the diamond shape in FIGS. 3 to 5, exemplary embodiments of the present inventive concept are not limited thereto. For example, the diamond shape may have a side that has a stair shape along the pixel area DA. An inside of the second touch electrode Rx_E may have the mesh shape however; exemplary embodiments of the present inventive concept are not limited thereto and the second touch electrodes Rx_E may have various shapes.

The first conductive layer 220 and the second conductive layer 230 may include a conductive metal however; the present disclosure is not limited to a particular type of conductive metal. For example, the conductive metal may include silver (Ag) and/or copper (Cu).

The first conductive layer 220 and the second conductive layer 230 may be substantially opaque. Since the touch panel 200 may be disposed under the display panel 100, displayed images may be seen when the first and second conductive layers 220 and 230 are substantially opaque.

The dot spacer 225 may be disposed on the first conductive layer 220. The dot spacer 225 may electrically connect the first conductive layer 220 to the second conductive layer 230 at a touch point. When the user touches the touch panel 200, the dot spacer 225 may electrically connect the first conductive layer 220 and the second conductive layer 230 to each other, and thus the touch panel 200 may detect the user's touch point. In other words, the touch panel 200 may be a resistive type touch panel 200. The dot spacer 225 may have a height less than a cell gap between the first substrate and the second substrate.

While the dot spacer 225 may electrically connect the first conductive layer 220 and the second conductive layer 230 to each other, exemplary embodiments of the present inventive concept are not limited thereto. For example, the dot spacer 225 may include a conductive metal, a polymer coated with as conductive metal, or carbon fiber.

The touch panel 200 may include a ball spacer (not shown) to maintain a distance between the lower substrate 210 and an upper substrate 240. The ball spacer may include an insulation material.

The touch panel 200 may include the upper substrate 240 disposed on the second conductive layer 230. The upper substrate 240 may be a transparent insulation substrate including glass or plastic.

Although an air gap 227 may be disposed between the first conductive layer 220 and the second conductive layer 230, exemplary embodiments of the present inventive concept are not limited thereto.

When the touch panel 200 is disposed under the display panel 100 having the bendable portion, a portion of the touch panel 200 may be bent. In other words, the touch panel 200 may be flexible.

The touch panel 200 may be disposed under the display panel 100 in the display device 10 according to an exemplary embodiment of the present inventive concept, and a surface brightness and transmissivity of the display panel 100 might not be deteriorated, and thus power consumption efficiency of the display device 10 may increase.

The display device 10 may include a lower adhesion film 500 between the touch panel 200 and the rear protection film 300. The touch panel 200 and the rear protection film 300 may be attached to each other by the lower adhesion film 500.

The lower adhesion film 500 may be a common adhesion film however exemplary embodiments of the present inventive concept are not limited thereto. For example, the lower adhesion film 500 may be a PSA film.

The display device 10 may include the rear protection film 300. The rear protection film 300 may be disposed under the touch panel 200 to protect the display panel 100 and the touch panel 200. The rear protection film 300 may prevent moisture from entering the rear surface of the display device 10 and may protect the display panel 100 and the touch panel 200 against an external impact.

The rear protection film 300 may include a shape memory alloy. The rear protection film 300 may have a desired restoring force and may have relatively high heat resistance. When the rear protection film 300 is highly elastic, the rear protection film 300 may have a relatively high bending characteristic and may be substantially flat. The shape memory alloy may be a common shape memory alloy however; exemplary embodiments of the present inventive concept are not limited thereto. For example, the shape memory alloy may be nitinol.

The rear protection film 300 may have a thickness of about 50 μm to about 100 μm. When the rear protection film 300 has a thickness less than about 50 μm, the protection of the display panel 100 and the touch panel 200 from external impact by the rear protection film 300 may be reduced.

A portion of the rear protection film 300 may be bendable. In other words, the rear protection film 300 may be flexible, and thus the rear protection film 300 may protect a flexible display panel.

The display device according to an exemplary embodiment of the present inventive concept may include the rear protection film 300 including the shape memory alloy, and thus the display device 10 may have a desired restoring three and may have a relatively high bending characteristic. The display device 10 may have relatively high heat resistance, may be durable against external impact and the display panel 100 and touch panel 200 may be substantially flat while having bendable portions.

In the display device 10 according to an exemplary embodiment of the present inventive concept, the display device 10 may increase power consumption efficiency, bending characteristics, and may be durable against external impact.

While the present inventive concept has been particularly shown and described with reference to exemplary embodiments thereof, it will be understood by those of ordinary skill in the art that various changes in form and detail may be made therein without departing from the spirit and scope of the present inventive concept, as defined by the following claims.

What is claimed is:

1. A display device, comprising:
a rear protection film comprising a shape memory alloy;
a touch panel disposed on the rear protection film, wherein the touch panel is configured to detect a user's touch, and a bendable display panel disposed on the touch panel.

2. The display device of claim 1, wherein the shape memory alloy comprises nitinol.

3. The display device of claim 1, wherein the rear protection film has a thickness of about 50 μm to about 100 μm.

4. The display device of claim 1, wherein a portion of the rear protection film is bendable.

5. The display device of claim 1, wherein the bendable display panel comprises an organic light emitting display panel, an electrophoretic display panel, or an electrowetting display panel.

6. The display device of claim 1, wherein the display device comprises an electronic book or an electronic paper.

7. The display device of claim 1, further comprising an upper adhesion film disposed between the bendable display panel and the touch panel.

8. The display device of claim 1, wherein the bendable display panel comprises a plurality of pixel areas and a non-display area surrounding the plurality of pixel areas.

9. The display device of claim 8, wherein the touch panel comprises:
a lower substrate;
a first conductive layer disposed on lower substrate;
a second conductive layer facing the first conductive layer; and
a dot spacer disposed on the first conductive layer, wherein the dot spacer electrically connects the first and second conductive layers to each other.

10. The display device of claim 9, wherein the first conductive layer comprises a first touch line extending in a first direction and overlapping the non-display area; and
the second conductive layer comprises a second touch line extending in a second direction different from the first direction and overlapping the non-display area.

11. The display device of claim 10 wherein the first touch line comprises first touch electrodes which are connected to each other in the first direction, wherein the first touch electrodes have a mesh shape, and wherein edges of the first touch electrodes have a diamond shape; and
the second touch line comprises second touch electrodes which are connected to each other in the second direction, wherein the second touch electrodes have a mesh shape, and wherein edges of the second touch electrodes have a diamond shape.

12. The display device of claim 9, wherein the dot spacer has a height less than a cell gap between the lower substrate and an upper substrate.

13. The display device of claim 9, wherein the first and second conductive layers comprise silver (Ag) or copper (Cu).

14. The display device of claim 9, wherein the first and second conductive layers are substantially opaque.

15. The display device of claim 9, wherein the touch panel further comprises an upper substrate disposed on the second conductive layer.

16. The display device of claim 1, wherein a portion of the touch panel is bendable.

17. The display device of claim 1, further comprising a lower adhesion film disposed between the touch panel and the rear protection film.

18. A display device, comprising:
a rear protection film comprising a shape memory alloy;
a lower adhesion film disposed on the rear protection film;
a touch panel disposed on the rear protection film;
an upper adhesion film disposed on the touch panel; and
a display panel disposed on the upper adhesion film.

19. The display device of claim 18, wherein the shape memory alloy comprises nitinol.

20. The display device of claim 18, wherein the touch panel comprises:
a lower substrate;
a first conductive layer disposed on the lower substrate;
a dot spacer disposed on the first conductive layer;
a second conductive layer disposed on the first conductive layer; and
an upper substrate disposed on the second conductive layer.

21. The display device of claim 18, wherein the display panel and the touch panel are bendable.

22. The display device of claim 18, wherein the display panel comprises a plurality of pixel areas configured to display an image and a non-display area.
